(19) United States
(12) Patent Application Publication
(10) Pub. No.: US 2024/0300327 A1
(43) Pub. Date: Sep. 12, 2024

(54) SYSTEM AND METHOD FOR APPLYING VEHICLE OPERATIONAL RULES ON DEMAND AND OVER THE AIR

(71) Applicant: WOVEN BY TOYOTA, INC., Tokyo (JP)

(72) Inventor: Ho Ki Wilson LAM, Tokyo (JP)

(73) Assignee: WOVEN BY TOYOTA, INC., Tokyo (JP)

(21) Appl. No.: 18/119,046

(22) Filed: Mar. 8, 2023

(51) Int. Cl. B60K 35/00; B60R 16/023; G06F 21/32

(52) U.S. Cl. CPC B60K 35/00; B60R 16/0231; G06F 21/32; B60K 35/10; B60K 35/65; B60K 35/80; B60K 35/85; B60K 2360/11; B60K 2360/55; B60K 2360/589

(57) ABSTRACT

Provided are method, system, and device for applying vehicle operational rules on demand and over the air. The method may be implemented by programmed one or more processors in a client terminal, for setting an operational rule of a vehicle, the method comprising; outputting a user interface for setting an operational rule for controlling one or more components of a vehicle; receiving, via a user input to the user interface, a setting of the operational rule; and transmitting the received setting to a server to implement the operational rule on the fly via an over-the-air transmission to the vehicle.

### TECHNICAL FIELD

Systems and methods consistent with example embodiments of the present disclosure relate to vehicles, and more particularly, to systems and methods for applying vehicle operational rules on demand and over the air.

### BACKGROUND

A vehicle may be shared by multiple people, for instance, the owner of a vehicle may allow another person to borrow the vehicle. However, the owner may intend for the borrower to only have limited use of the vehicle. For example, the owner may allow their child to borrow their car for limited use or purpose, or allow a garage attendant or valet attendant to use the car in order to park it. In such cases, the temporary operator may be inexperienced or lack attention to safe operation of the vehicle.

Accordingly, there is a need for an owner of a vehicle to be able to apply operational rules over-the-air and on demand when allowing others to drive the vehicle.

### SUMMARY

According to embodiments, methods, systems and devices are provided for applying operational rules for a vehicle on demand and over the air. By allowing a user to remotely set operational rules for a vehicle from a client terminal (e.g., mobile phone) and implementing the operational rules on the fly via an over-the-air transmission to the vehicle, an owner of a vehicle may restrict or otherwise control use of the vehicle on demand to thereby prevent unsafe driving by a careless or inexperienced driver.

According to embodiments, a method, which may be implemented by programming one or more processors in a client terminal, for setting an operational rule of a vehicle may be provided. The method may include, the method may include: outputting a user interface for setting an operational rule for controlling one or more components of a vehicle; receiving, via a user input to the user interface, a setting of the operational rule; and transmitting the received setting to a server to implement the operational rule on the fly via an over-the-air transmission to the vehicle.

Outputting of the user interface may include outputting the user interface based on a successful authentication of the user.

The successful authentication of the user may be verified based on one of a login procedure and/or biometric authentication.

The one or more components may include at least one of an infotainment system, a temperature setting, a volume setting, seat positioning, a window lock, a door lock, a trunk lock, a hood lock, a compartment lock, high beams, a Bluetooth or hands free telephone function, and an autonomous driving control.

The operational rule may include a condition and a control to be performed based on the condition. The condition may also include at least one of a number of passengers, a location, a distance traveled, a time of travel, a time, a drowsiness detection, and a careless driving detection.

The method may further include receiving, from the server, a notification of the condition being met.

According to embodiments, an apparatus for managing configuration schema for setting an operational rule of a vehicle may be provided, the apparatus may include: at least one memory storing computer-executable instructions; and at least one processor configured to execute the computer-executable instructions to: output a user interface for setting an operational rule for controlling one or more components of a vehicle; receive, via a user input to the user interface, a setting of the operational rule; and transmit the received setting to a server to implement the operational rule on the fly via an over-the-air transmission to the vehicle.

The at least one processor is further configured to execute the computer-executable instructions to output the user interface by outputting the user interface based on a successful authentication of the user.

The at least one processor may also be further configured to execute the computer-executable instructions to: receive, from the server, a notification of the condition being met.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system for communicating with one or more vehicles using a client terminal and a server, according to one or more embodiments;

FIG. 2 illustrates a diagram of example components of a server, according to one or more embodiments;

FIG. 3 illustrates a flow diagram of an example method for setting an operational rule for operating a vehicle, according to one or more embodiments;

FIG. 4 illustrates a diagram of example components of a vehicle, according to one or more embodiments;

FIG. 5 illustrates an example of a operational rule table, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Examples embodiments of the present disclosure provides a method and a system for applying operational rules for a vehicle on demand and over the air. By allowing a user to remotely set operational rules for a vehicle from a client terminal (e.g., mobile phone) and implementing the operational rules on the fly via an over-the-air transmission to the vehicle, an owner of a vehicle may restrict or otherwise control use of the vehicle on demand to thereby prevent unsafe driving by a careless or inexperienced driver.

Examples of the components of the vehicle which may be controlled include, without limitation, one or more (e.g., all) functions of an infotainment system, sound system volume controls, temperature control, seat positioning, windows, sunroof, locks, trunk access, hood access, vehicle speed, compartment access, high beams, autonomous driving controls, etc. Examples of operational rules include, without limitation, a limit on a number of passengers, restrictions with respect to an infotainment system, restrictions with respect to use of high beams, restricting access to a trunk or front hood (e.g., by maintaining a lock thereof), locking all doors except for a driver's door and/or one or more passenger doors, etc.

Further, the operational rules may include compound or conditional rules (e.g., if X, then Y), such as limiting or restricting certain uses or operations of the vehicle based on certain conditions being met (e.g., disabling specified functions of the vehicle based on location parameters (e.g., designated no go zones and/or a designated zone where use is permitted) or a number of passengers detected in the vehicle). Examples of conditional parameters include, without limitation, location, occupancy limit/number of passengers (e.g., detected by weight sensors under the seats, optical sensors, or other means), safe driving parameters (e.g., detected based on a lane drifting sensor, drowsiness detection, hard braking detection, following distance detection, careless driving detection, etc.), driver alertness parameters, driving distance, time of driving, time, etc. The location may be provided as a particular latitude and longitude, or as a range or area.

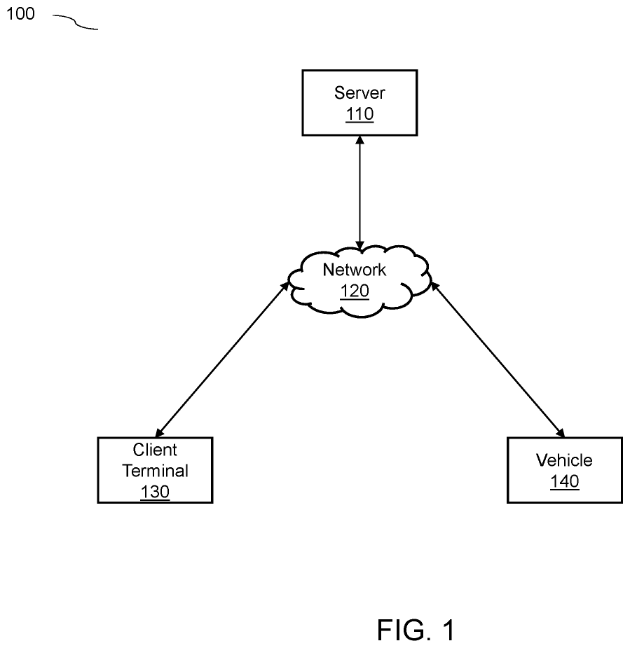

FIG. 1 illustrates a block diagram of an example system 100 for communicating with a vehicle via a server and client terminal, according to one or more embodiments. Referring to FIG. 1, system 100 may include a server 110, a network 120, a client terminal 130, and a vehicle 140.

The server 110 may be communicatively coupled to the client terminal 130 via the network 120. The server 110 and client terminal 130 may be configured to transmit and to receive information to-and-from one another. The server 110 may also be communicatively coupled to the vehicle 140 via the network 120. The server 110 and vehicle 140 may be configured to transmit and to receive information to-and-from one another. The information may be exchanged among the server 110 and the client terminal 130 and/or vehicle 140 in the form of a signal, network data, and any other suitable form.

Network 120 may include one or more data links that enable the transport of electronic data between server 110 and client terminal 130 and/or vehicle 140 (and the components or systems included therein). In this regard, network 120 may include one or more wired and/or wireless networks. For example, network 120 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a Wireless Fidelity (WiFi) network, a private network, a Bluetooth™ network, an ad hoc network, an intranet, the Internet, a fiber optic-based network, or the like, and/or a combination of these or other types of networks. According to other embodiments, the server 110 may be configured to broadcast or multicast a signal including information on an operational rule for operating the vehicle. The signal may be transmitted to vehicle 140 via on demand, or an over-the-air (OTA) transmission using network 120.

The server 110 may include one or more devices capable of receiving, generating, storing, processing, computing, and/or providing information or data. According to embodiments, server 110 may include a cloud server or a group of cloud servers (e.g., server cluster, etc.). According to embodiments, server 110 may be constituted by a plurality of servers, a portion of which may be deployed in different locations. For instance, server 110 may include: an edge server deployed nearby vehicle 140, a central server deployed further from the vehicle 140, and the like.

Client terminal 130 may include one or more devices capable of allowing a user to input data (for example, a mobile phone, a desktop computer, etc.). Furthermore, the client terminal 130 may be configured to provide a user interface by means of a mobile phone application, a browser web page, or any other appropriate means for allowing the user to input data for setting operational rules for operating the vehicle. The user interface may be provided to client terminal 130 via server 110. According to embodiments, the user interface may only be accessible by an authenticated/registered user (i.e., the owner). Verifying the user's authentication/registration may be performed by logging in (for example, by submitting a username and password of an authenticated/registered user, or via biometric authentication). The user interface may be configured to transmit the inputted user data to server 110, which may subsequently be transmitted to vehicle 140.

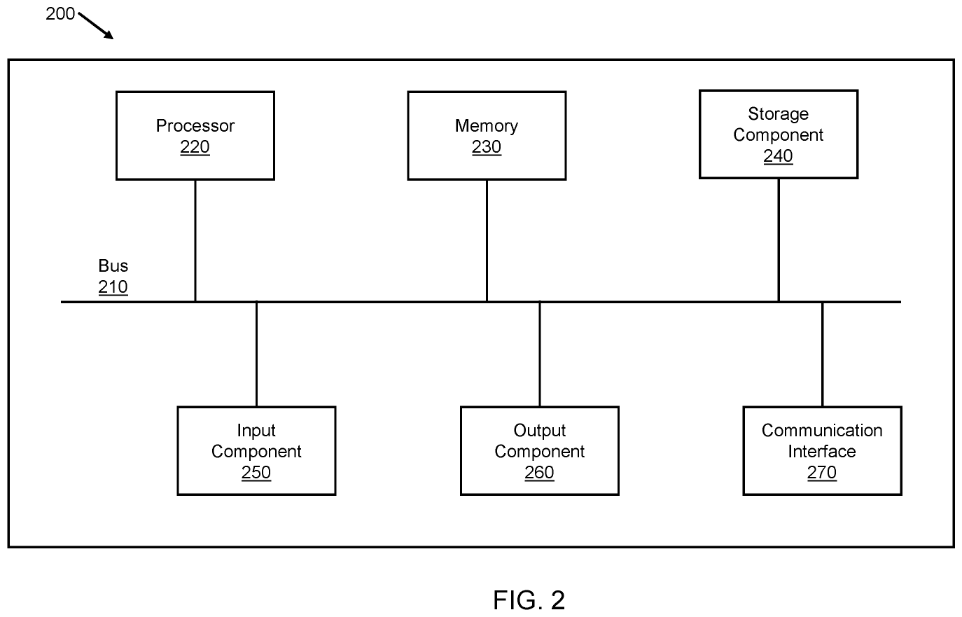

FIG. 2 illustrates a diagram of example components of a device 200, according to one or more embodiments. Device 200 may be used to implement server 110 or client terminal 130 in FIG. 1, thus the descriptions associated with device 200, server 110, and client terminal 130 may be applicable to each other, unless being explicitly described otherwise.

Referring to FIG. 2, device 200 may include a bus 210, a processor 220, a memory 230, a storage component 240, an input component 250, an output component 260, and a communication interface 270.

Bus 210 may include one or more components that permit communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing or computing component. In some implementations, processor 220 may include one or more processors capable of being programmed to perform a function. Memory 230 may include a random access memory (RAM), a read only memory (ROM), and/or another type of dynamic or static storage device (e.g., a flash memory, a magnetic memory, and/or an optical memory) that stores information and/or instructions for use by processor 220.

Storage component 240 may store information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 may include one or more components that permit device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 may include one or more components that provide output information from device 200 (e.g., a display, a speaker, and/or one or more light-emitting diodes (LEDs)).

Communication interface 270 may include a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device (e.g., device included in the plurality of vehicles, etc.) and/or provide information to said another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

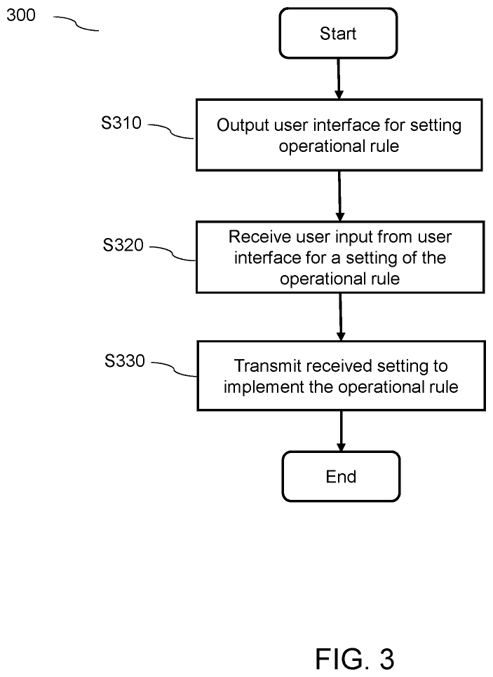

FIG. 3 illustrates a flow diagram of an example method 300 for setting an operational rule for operating a vehicle, according to one or more embodiments.

Referring to FIG. 3, at operation S310, a user interface for setting one or more operational rule(s) for controlling one or more component(s) of a vehicle is output to the user. The user interface may be a web portal, and may be provided to client terminal 130 from server 110 (for example, a mobile phone application, web browser page, etc.). According to an example embodiment, the user may be asked to perform an authentication procedure prior to accessing the user interface, in order to verify that the user is an authenticated user (i.e., the owner of the vehicle). The authentication procedure can be, without limitation, a login username and password, biometric authentication, etc.

At operation S320, user input for setting the operational rule is received from the user interface. The user input may be received from any appropriate means from client terminal 130 (for example, a physical or virtual keyboard, touchscreen, etc.). According to an example embodiment, the user interface may allow for the user to define a customized operational rule. This may be done by allowing the user to select one or more relevant vehicle component(s) (functions of an infotainment system, sound system volume controls, seat positioning, windows, sunroof, locks, trunk access, hood access, vehicle speed, compartment access, high beams, autonomous driving controls, etc.) and choose from pre-defined parameters (for example, an “on” or “off” option) and/or defining a specific parameter (defining a specific location, speed limit for the vehicle, etc.). The user may be able to further select pre-defined parameters which impose a condition for applying the operational rule (e.g., numbers of passengers/occupancy limit, accumulated time of driving, time of use, distance of driving, etc.). Alternatively, the user may simply select from an operational rule was already previously defined. According to an example embodiment, the service provider (e.g., the vehicle manufacturer) may provide an entire set of default operational rules in order to allow for the user to quickly configure the vehicle. It should be appreciated that multiple operational rule(s) can be composited into a single option for the user to input. For example, a “learning mode” may be an option wherein the speed of the vehicle is limited to be below a predetermined speed, and include an option to autonomously guide the vehicle to a safe location if it is determined that the vehicle has left some designated location.

The user may also be able to implement or set the operational rules real-time (e.g., real-time disciplining or control). For example, server 110 may send a notification/alarm to the user via client terminal 130, that vehicle 140 has met some condition (such a condition may be detected by a sensor in the vehicle). This condition may be previously specified by the user in the user interface, or be triggered by default (for example, a notification may be sent be default if the speed limit is being exceeded). Based on receiving the notification/alarm, the user may be provided with an option to set an operational rule.

For example, the navigational system of the vehicle may detect that the operator of vehicle 140 has left a designated location (this location may have been previously been set by the user via the user interface). Accordingly, vehicle 140 may send a signal to server 110 indicating that the vehicle has left the designated location, and server 110 may send the notification/alarm to the user via client terminal 130. The user may then be presented with an option to set an operational rule to restrict the vehicle's operation. This may include, but is not limited to, transition the vehicle to a limp mode in which the speed does not exceed a predetermined speed, limit the vehicle speed to a speed limit of a current road on which the vehicle is traveling, limit the vehicle speed to some predetermined speed below the speed limit of the current road, output a navigation control to direct or guide the user back to the designated location, activate autonomous control of the vehicle to return the vehicle to the designated location or guide the vehicle to a safe parking location, disable the infotainment system, etc.

At operation S330, the received setting for the operational rule from the user input in operation S320 is transmitted to the vehicle to implement the operational rule. Specifically, client terminal 130 may transmit the received setting to the server 110. According to one embodiment, the setting may be processed by the server (for example, to verify that the setting is valid, that the vehicle 140 is available to receive the setting, etc.). Server 110 may also save the received setting into memory/storage. Subsequently, server 110 may transmit the received setting for the operational rule to vehicle 140. According to one embodiment, vehicle 140 may process the received setting for the operational rule (for example, to verify that the setting is received from a valid source, to convert the setting to a usable form, etc.). Vehicle 140 may also save the received setting into memory/storage. Subsequently, vehicle 140 may implement the operational rule.

For example, if the user had set an operational rule to restrict use of an infotainment system if more than one person occupies the vehicle (e.g., if one or more passengers are in the vehicle in addition to the driver), after receiving the setting for the operational rule, the vehicle may receive sensor information from weight sensors under seats of the vehicle or image sensor information (processed to detect passengers) in order to determine whether the condition has been satisfied, i.e., to determine whether one or more passengers occupy the vehicle. Based upon such determination, the controller in the vehicle may be configured to deactivate the infotainment system.

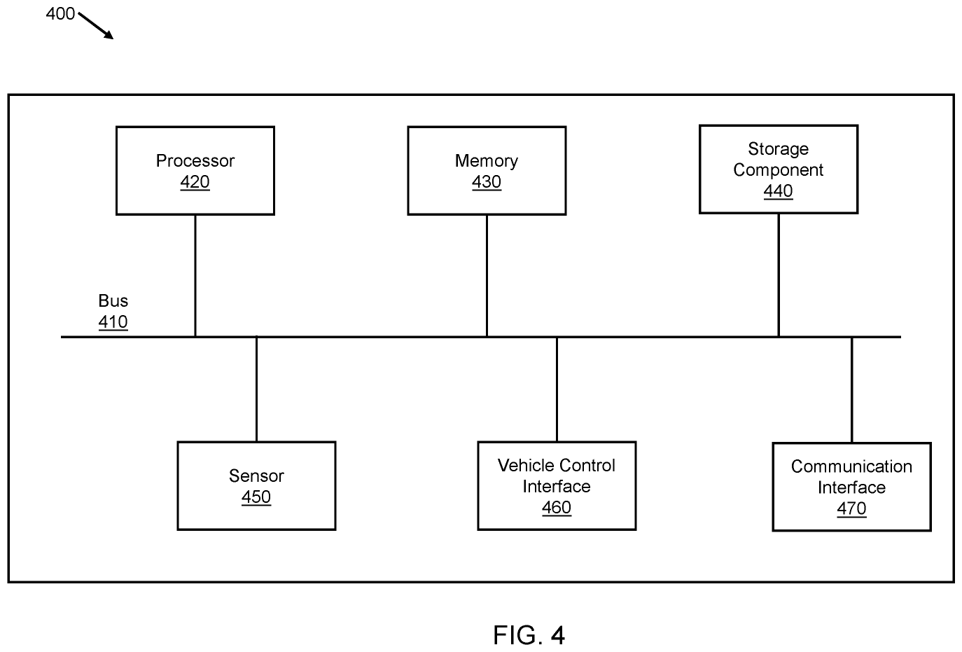

FIG. 4 illustrates a diagram of example components of a vehicle 400, according to one or more embodiments. Vehicle 400 may be similar to vehicle 140 in FIG. 1, thus the descriptions associated with vehicle 400 and vehicle 140 may be applicable to each other, unless being explicitly described otherwise.

Further, vehicle 400 may include any motorized and/or mechanical machine which may carry or transport people and/or cargo, such as: a car, a truck, a motorcycle, a bus, a bicycle, a mobility scooter, an aerial vehicle, and the like.

Referring to FIG. 4, vehicle 400 may include a bus 410, a processor 420, a memory 430, a storage component 440, a sensor 450, vehicle control interface 460, and a communication interface 470. The general functions and roles of the bus 410, the processor 420, the memory 430, the storage component 440, and the communication interface 470 may be similar to the bus 210, the processor 220, the memory 230, the storage component 240, and the communication interface 270, respectively, described above with reference to FIG. 2. Thus, redundant descriptions associated therewith may be omitted herein for conciseness. Further, it can be understood that vehicle 400 may also include input component and output component having a similar functions and role of input component 250 and output component 260, without departing from the scope of the present disclosure.

Referring to FIG. 4, vehicle 400 may include at least one sensor 450 configured to detect, measure, and capture respective data (may be referred to as “sensor data” herein). For instance, the at least one sensor 450 may include: an accelerometer which measures and captures data associated with the acceleration/deceleration of the vehicle, the vehicle speed, and/or the vehicle travel distance; an image sensor (e.g., camera, etc.) which detects and captures image data surrounding or nearby the vehicle; a light detection and ranging (LiDAR) sensor which detects and captures data associated with light in one or more light spectrums, such as the visible spectrum, the infrared spectrum, the ultraviolet spectrum, and/or any other light spectrums; an audio sensor (e.g., microphone, etc.) which may detect and capture audio data internal and/or external to the vehicle; a temperature sensor which measures and captures data associated with temperature internal and/or external to the vehicle; a location sensor (e.g., global positioning system (GPS), inertial measurement unit (IMU), etc.) which measures and captures data associated with the location, position, and/or orientation of the vehicle; a contact sensor (e.g., pressure detector, impact detector, etc.) which detects and captures data between a portion of the vehicle and an object; an air sensor which measure and captures data associated with the air (e.g., oxygen level, pollution level, humidity level, etc.) internal and/or external to the vehicle; a weight sensor for determining whether there are passengers (e.g., weight sensors deployed under the seats) and any other sensors suitable to be deployed in the vehicle.

The sensor data may be persistently or semi-persistently stored in the vehicle 400 (e.g., store in memory 430 and/or storage component 440, etc.) for a predetermined period of time. The sensor data may be captured periodically, continuously, intermittently, or based on a trigger event (e.g., a loud sound, a horn actuation, a quick deceleration or hard braking, a quick turn, etc.). Further, a portion or all of the sensor data may be processed by the processor 420 before and/or after storing to the storage medium(s).

With reference to operation S330 in FIG. 3, the sensor data may be interpreted by processor 420 as to whether it matches any of the conditions set by the user.

Referring to FIG. 4, vehicle 400 may include a vehicle control interface 460. Vehicle control interface 460 may be used to control specific components used in the vehicle operation (steering, vehicle speed, etc.), or vehicle accessories (the infotainment system, seat settings, etc.). Vehicle control interface 460 may receive an instruction from processor 420 based on the operational rule, for example, if a condition set by the user is triggered with reference to an operational rule, the vehicle control interface 460 may transmit a control signal to control the specific vehicular component based on the operational rule. According to one embodiment, vehicle control interface 460 may operate directly in response to sensor data sent from sensor 450.

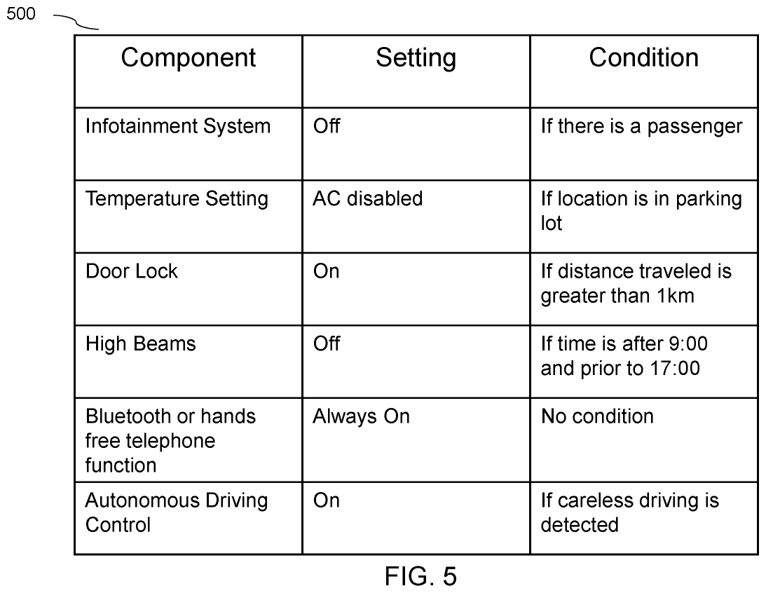

FIG. 5 illustrates an example of an operational rule table 500, according to one or more embodiments. Operational rule table 500 may be implemented at any of server 110, client terminal 130, or vehicle 140. For example, operational rule table 500 may be sent from client terminal 130 to the server 110 and subsequently sent to vehicle 140, 400. According to another embodiment, operational rule table 500 may be stored and updated in the vehicle 140, 400 (e.g., in memory 430 and/or storage component 440, etc.) based on operational rules received from server 110.

The operational rules may be stored based on which component it applies to, what the setting is, and what the condition for applying the operational rule is (if applicable). For example, as illustrated in FIG. 5, a first operational rule may be relevant to the infotainment system of the vehicle, and the setting is “off” (for example, this means that the radio in the vehicle can be turned on and/or music can be played), and the condition is if there is a passenger (this may be determined based on weight sensors in the seats of the vehicle and the like). Another operational rule may not have any condition. Referring still to FIG. 5, another operational rule may be relevant to the Bluetooth or hands free telephone function, and the setting is “always on”, without any condition.

It should be understood that operational rule table 500 is an example of how the data may be stored, and alternatively the operational rules can each be stored as a separate data/file on a per-component basis. It should also be appreciated that the operational rules illustrated in FIG. 5 are merely examples thereof, and example embodiments of the present disclosure are not limited thereto.

In view of the above, examples embodiments of the present disclosure provides a method and a system for applying operational rules for a vehicle on demand and over the air. By allowing a user to remotely set operational rules for a vehicle from a client terminal (e.g., mobile phone) and implementing the operational rules on the fly via an over-the-air transmission to the vehicle, an owner of a vehicle may restrict or otherwise control use of the vehicle on demand to thereby prevent unsafe driving by a careless or inexperienced driver.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method, implemented by programmed one or more processors in a client terminal, for setting an operational rule of a vehicle, the method comprising;
outputting a user interface for setting an operational rule for controlling one or more components of a vehicle;
receiving, via a user input to the user interface, a setting of the operational rule; and
transmitting the received setting to a server to implement the operational rule on the fly via an over-the-air transmission to the vehicle.

2. The method according to claim 1, wherein the outputting of the user interface comprises outputting the user interface based on a successful authentication of the user.

3. The method according to claim 2, wherein the successful authentication of the user is verified based on one of a login procedure and/or biometric authentication.

4. The method according to claim 1, wherein the one or more components comprise at least one of an infotainment system, a temperature setting, a volume setting, seat positioning, a window lock, a door lock, a trunk lock, a hood lock, a compartment lock, high beams, a Bluetooth or hands free telephone function, and an autonomous driving control.

5. The method according to claim 1, wherein the operational rule comprises a condition and a control to be performed based on the condition.

6. The method according to claim 5, wherein the condition comprises at least one of a number of passengers, a location, a distance traveled, a time of travel, a time, a drowsiness detection, and a careless driving detection.

7. The method according to claim 5, further comprising receiving, from the server, a notification of the condition being met.

8. An apparatus for managing configuration schema for setting an operational rule of a vehicle, the apparatus comprising:
at least one memory storing computer-executable instructions; and
at least one processor configured to execute the computer-executable instructions to:
output a user interface for setting an operational rule for controlling one or more components of a vehicle;
receive, via a user input to the user interface, a setting of the operational rule; and
transmit the received setting to a server to implement the operational rule on the fly via an over-the-air transmission to the vehicle.

9. The apparatus according to claim 8, wherein the at least one processor is further configured to execute the computer-executable instructions to output the user interface by outputting the user interface based on a successful authentication of the user.

10. The apparatus according to claim 9, wherein the successful authentication of the user is verified based on one of a login procedure and/or biometric authentication.

11. The apparatus according to claim 8, wherein the one or more components comprise at least one of an infotainment system, a temperature setting, a volume setting, seat positioning, a window lock, a door lock, a trunk lock, a hood lock, a compartment lock, high beams, a Bluetooth or hands free telephone function, and an autonomous driving control.

12. The apparatus according to claim 8, wherein the operational rule comprises a condition and a control to be performed based on the condition.

13. The apparatus according to claim 12, wherein the condition comprises at least one of a number of passengers, a location, a distance traveled, a time of travel, a time, a drowsiness detection, and a careless driving detection.

14. The apparatus according to claim 12, wherein the at least one processor is further configured to execute the computer-executable instructions to: receive, from the server, a notification of the condition being met.

15. A non-transitory computer-readable recording medium having recorded thereon instructions executable by at least one processor to cause the at least one processor to perform a method for outputting a user interface for setting an operational rule for controlling one or more components of a vehicle, the method comprising:
receiving, via a user input to the user interface, a setting of the operational rule; and
transmitting the received setting to a server to implement the operational rule on the fly via an over-the-air transmission to the vehicle.

16. The non-transitory computer-readable recording medium according to claim 15, wherein the outputting of the user interface comprises outputting the user interface based on a successful authentication of the user.

17. The non-transitory computer-readable recording medium according to claim 16, wherein the successful authentication of the user is verified based on one of a login procedure and/or biometric authentication.

18. The non-transitory computer-readable recording medium according to claim 15, wherein the one or more components comprise at least one of an infotainment system, a temperature setting, a volume setting, seat positioning, a window lock, a door lock, a trunk lock, a hood lock, a compartment lock, high beams, a Bluetooth or hands free telephone function, and an autonomous driving control.

19. The non-transitory computer-readable recording medium according to claim 15, wherein the operational rule comprises a condition and a control to be performed based on the condition.

20. The non-transitory computer-readable recording medium according to claim 19, wherein the condition comprises at least one of a number of passengers, a location, a distance traveled, a time of travel, a time, a drowsiness detection, and a careless driving detection.
